(19) United States
(12) Patent Application Publication
(10) Pub. No.: US 2026/0110355 A1
(43) Pub. Date: Apr. 23, 2026

(54) LUBRICANT SUPPLY SYSTEM FOR FINAL DRIVE

(71) Applicant: DEERE & COMPANY, MOLINE, IL (US)

(72) Inventors: TOBIAS STEINER, Zum Weißen Kreuz (DE); Jonas Buse, Karlsruhe (DE); Shaligram Tambe, PUNE (IN)

(21) Appl. No.: 19/339,374

(22) Filed: Sep. 25, 2025

(30) Foreign Application Priority Data
Oct. 18, 2024 (EP) 24207351.8

(51) Int. Cl. F16H 57/04

(52) U.S. Cl. CPC F16H 57/0479; F16H 57/0424; F16H 57/0441; F16H 2700/02

(57) ABSTRACT

A lubricant supply system for a final drive comprises a housing with an input shaft, a planetary gear, and a drivable axle. The axle is supported on the housing by an inner bearing assembly and an outer bearing assembly can be driven by the input shaft via the planetary gear, and is coupled to a wheel flange for receiving a wheel. The lubricant supply system comprises a first channel section, with which the outer bearing assembly can be supplied with a lubricant from a reservoir by a pump, a second channel section, with which the lubricant can be carried from the outer bearing assembly to the inner bearing assembly, and a third channel section, with which the lubricant can be carried from the inner bearing assembly to the planetary gear.

### CROSS-REFERENCE TO RELATED APPLICATIONS

This application claims priority to European Patent Application No. 24207351.8, filed Oct. 18, 2024, which is hereby incorporated by reference.

### TECHNICAL FIELD

The present disclosure relates generally to a lubricant supply system for a final drive.

### BACKGROUND

To keep final drives working, axle bearings and moving elements of planetary gear must be supplied with lubricant (oil). The lubricant supply system is typically provided by a differential, which is connected to the final drive housing by openings through which the lubricant contained in the differential can flow into the inside of a final drive housing and back into a differential housing.

### SUMMARY

According to an aspect of the present disclosure, a lubricant supply system for a final drive is disclosed. The final drive includes a housing, an input shaft, a planetary gear, a drivable axle supported on the housing by an inner bearing assembly and an outer bearing assembly, configured to be driven by the input shaft via the planetary gear, and coupled to a wheel flange for receiving a wheel. The lubricant supply system comprising a first channel section, with which the outer bearing assembly can be supplied with a lubricant from a reservoir by a pump, a second channel section, with which the lubricant can be carried from the outer bearing assembly to the inner bearing assembly, and a third channel section, with which the lubricant can be carried from the inner bearing assembly to the planetary gear.

According to an aspect of the present disclosure, a final drive having a lubricant supply system is disclosed. The final drive comprises a housing, an input shaft, a planetary gear, a drivable axle supported on the housing by an inner bearing assembly and an outer bearing assembly, configured to be driven by the input shaft via the planetary gear, and coupled to a wheel flange for receiving a wheel, and a lubricant supply system. The lubricant supply system includes a first channel section, with which the outer bearing assembly can be supplied with a lubricant from a reservoir by a pump, a second channel section, with which the lubricant can be carried from the outer bearing assembly to the inner bearing assembly, and a third channel section, with which the lubricant can be carried from the inner bearing assembly to the planetary gear.

According to an aspect of the present disclosure, an axle assembly for a rear axle of an agricultural tractor is disclosed. The axle assembly comprises a different and final drives arranged on both sides of the differential. Each of the final drives includes a housing, an input shaft, a planetary gear, a drivable axle supported on the housing by an inner bearing assembly and an outer bearing assembly, configured to be driven by the input shaft via the planetary gear, and coupled to a wheel flange for receiving a wheel, and a lubricant supply system. The lubricant supply system includes a first channel section, with which the outer bearing assembly can be supplied with a lubricant from a reservoir by a pump, a second channel section, with which the lubricant can be carried from the outer bearing assembly to the inner bearing assembly, and a third channel section, with which the lubricant can be carried from the inner bearing assembly to the planetary gear.

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1 shows a vertical section through a final drive for an agricultural tractor.

FIG. 2 shows a perspective view of a bushing for transporting the lubricant to the outer bearing assembly.

FIG. 3 shows a perspective view of a planetary gearwheel.

FIG. 4 shows a section through the planetary gearwheel of FIG. 3.

FIG. 5 shows a perspective view of an element for feeding lubricant to the planet carrier from a first side.

FIG. 6 shows a perspective view of the feed element in FIG. 5 from a second side.

FIG. 7 shows a perspective view of the final drive in the assembled state.

FIG. 8 shows an exploded view of the final drive.

Like reference numerals are used to indicate like elements throughout the several figures.

### DETAILED DESCRIPTION

In some motor vehicles, especially in the case of rear axles of agricultural tractors, wheels are driven via a differential and final drives arranged on both sides thereof, which include a reduction gear stage. The final drives are driven by an input shaft drive-connected to the differential. The input shaft is torque-locked to a sun wheel of a planetary gear, while the planet carriers are coupled to the driven axle, to which a wheel in engagement with the ground is attached. The final drive housing is connected to the annulus of the planetary gear. The driven axle is supported rotatably on inner and outer axle bearings in the final drive housing. In this regard, attention is drawn, for example, to the references according to U.S. Pat. No. 3,515,246 A and JPS 59118602 U.

Since agricultural vehicles are operated not only on horizontal surfaces but also on side slopes, there is a risk that the uphill final drive will not be supplied with sufficient lubricant. In order to avoid having to fill the housings of the final drives with lubricant completely or at least to a height such that the highest final drive element to be lubricated is bathed in the lubricant even at the greatest possible lateral inclination, the reference according to U.S. Pat. No. 3,515,246 A provides for the installation, in the journals of the planet wheels, of trough-type reservoirs that dip into the lubricant reservoir at the bottom of the final drive housing during their rotation and supply lubricant to the inner bearing assemblies of the driven axle via guide elements during their upward rotation. A seal is located between the axle and the final drive housing, directly adjacent to the outside of the inner bearing assembly. The differential and the two final drives form a common, oil-tight housing and communicate with each other through the bearing assemblies that support the input shafts in the differential housing, allowing the lubricant to flow between the differential housings and the final drives. The manner in which the outer bearings, which are located at the outer ends of the axle, are supplied with lubricant is not disclosed.

A similar arrangement with a reservoir in the journals of the planet wheels of a final drive, but for lubrication of the planet wheel bearings, is shown by DD 243 739 A1.

Further arrangements for supplying planet wheel bearing assemblies with lubricant which have not been described in connection with final drives provide for a supply of lubricant through an axial channel of the shaft with a radial outlet opening and a lubricant collecting pocket, which supplies a channel structure in the planet journal with lubricant, through which it reaches the planet wheel bearing (DE 10 2021 123 097 B3), or provide a side plate of the planet carrier with a groove that directs the lubricant from the shaft to the planet wheel bearing (DE 11 2006 000 382 T5), or lines supplied with lubricant are used to lubricate the planet wheel bearings (US 2014/0287864 A1) and the meshing teeth of the planets and the annulus (US 2015/0300255 A1).

In consideration of all this, it may be stated that, in the case of previous final drives, cf. JPS 59118602 U, the lubrication of the bearing assemblies and of the gearwheel surfaces of the planet gears that are in engagement therewith is based on the fact that they dip into a lubricant reservoir in the housing of the final drive, at least during part of their revolution. This lubricant is provided from the housing of the differential. For this reason, a certain height of the lubricant reservoir has to be provided, this leading, on the one hand, to friction on account of splashing when the planet wheels dip into the lubricant reservoir and, on the other hand, there is the problem on side slopes of the dropping level of lubricant on the uphill side. The arrangements according to U.S. Pat. No. 3,515,246 A and DD 243 739 A1 only partially mitigate this problem since, during their revolution, they take up the lubricant into cavities in journals of the planet wheels, take it along toward the top and discharge it again there.

The object underlying the disclosure is considered to be that of providing a final drive with which the problems described are not present or are present to a reduced extent.

This object is achieved according to the disclosure by the teaching of one or more embodiments disclosed herein. The features of one or more embodiments disclosed herein advantageously develop the solution.

A lubricant supply system for a final drive comprising a housing with an input shaft, a planetary gear and a drivable axle, wherein the axle is supported on the housing by an inner bearing assembly and an outer bearing assembly, can be driven by the input shaft via the planetary gear and is coupled to a wheel flange for receiving a wheel, is distinguished by the fact that the lubricant supply system comprises a first channel section, with which the outer bearing assembly can be supplied with a lubricant from a reservoir by a pump, a second channel section, with which the lubricant can be carried from the outer bearing assembly to the inner bearing assembly, and a third channel section, with which the lubricant can be carried from the inner bearing assembly to the planetary gear.

In other words, the lubricant is supplied to the final drive from a pump via a first channel section to the outer bearing assembly of the axle on the housing, from there, via a second channel section, to the inner bearing assembly of the axle on the housing and, from there, via a third channel section to the planetary gear. Thus, an active lubricant supply is provided which reaches all the final drive components to be lubricated, namely the two bearings and the planetary gear, in succession.

In this way, the final drive components to be lubricated are supplied in a targeted and continuous way, irrespective of any gradient on a side slope. By virtue of the continuous supply, controlled lubrication and dissipation of any frictional heat from the bearing assemblies and from the planetary gear is furthermore achieved, and this leads to a longer life, longer service intervals and reduced noise development in the final drive, and the oil level in the final drive can be reduced in comparison with previous final drives, something which, inter alia, also reduces splash losses and improves efficiency.

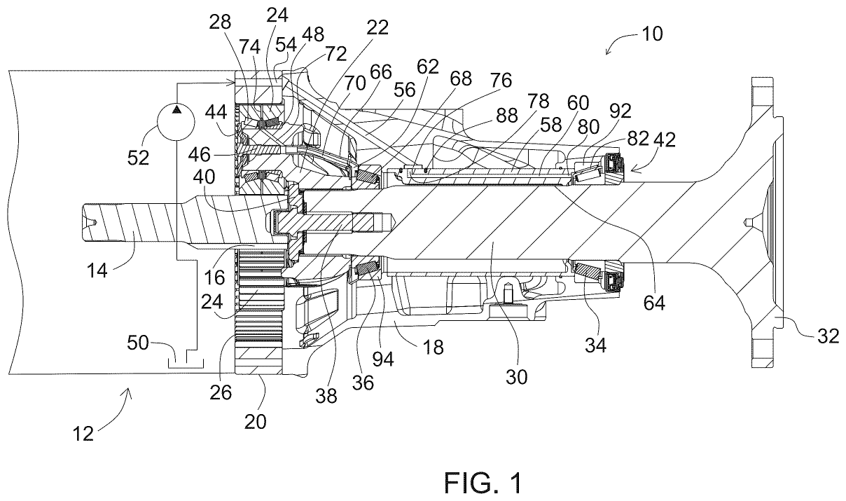

FIG. 1 shows a vertical section through a final drive 10. The final drive 10 forms a drive connection between a differential 12 and a wheel flange 32 on which a rim of a wheel is mounted or has been mounted, and furthermore serves as a mechanical connection between the differential 12 and the wheel flange 32. In a manner that is known per se and is therefore not shown in the figures, the differential 12 has a drive shaft, which is in drive connection via gearwheels with two input shafts 14 of final drives 10 arranged on each side of the differential 12. The drive shaft of the differential 12 is driven, in turn, by a drive motor, usually an internal combustion engine, and a transmission with a selectable transmission ratio. Further details in this regard are described in U.S. Pat. No. 3,515,246 A and JPS 59118602 U, for example, the disclosure of which is included by reference in the present documents.

The final drive 10 comprises an annular flange 20, which is screwed to the housing of the differential 12, and a housing 18 connected thereto, which adjoins the flange 20 on the outside in the axial direction. The input shaft 14 extends into the flange 20 and there forms a toothed sun wheel 16 of a planetary gear, which serves to reduce the speed of the input shaft 14 relative to an output shaft, referred to below as axle 30, of the final drive 10, which output shaft is connected to the wheel flange 32 or is produced integrally therewith. A number of toothed planet wheels 24 (three in the present embodiment) are supported on a planet carrier 22, which is rigidly connected to the inner end of the axle 30, by bearing assemblies 28 fitted with rolling bearings. The planet wheels 24 mesh with the sun wheel 16 and with a tooth system 26, which is provided on the inner circumference of the flange 20 and serves as an annulus.

In the present case, the axial direction corresponds to the axis of symmetry of the axle 30, which runs from left to right in FIG. 1, and the radial direction runs transversely thereto, in the vertical direction in FIG. 1. In the axial direction, the axle 30 extends from an inner end, on the left in FIG. 1, to an outer end, on the right in FIG. 1. In the radial direction, the direction indication “outside” should be understood to mean away from the axis of symmetry of the axle 30 and “inside” is in the opposite direction thereto.

The planet carrier 22 is mounted on the axle 30 by a pressure washer 40 and a screw 38, which presses a conical end section of the planet carrier 22 onto a likewise conical end section of the axle 30. Both end sections are usually provided in the circumferential direction with interacting features, e.g. tooth systems.

Adjacent to the planet carrier 22, the axle 30 is supported rotatably in the housing 18 of the final drive 10 by an inner bearing assembly 36 that is fitted with rolling bearings and is supported on a ring 94. Adjacent to the outer end of the housing 18, said end being adjacent to the wheel flange 32, an outer bearing assembly 34 fitted with rolling bearings is likewise located between the housing 18 and the axle 30 and is supported on a ring 92. Adjacent to the outer bearing assembly 34, the housing 18 is sealed at the outer end with respect to the axle 30 by a sealing assembly 42.

The bearing assemblies 28 of the planet wheels 24 are pressed against a shoulder 48 of the planet carrier 22 by washers 44 and screws 46 and thus fixed in the axial direction.

A pump 52 is provided in the differential 12 to supply the final drive 10 with lubricant and it takes the lubricant, generally transmission oil, from a reservoir 50 at the bottom of the differential 12 and delivers it through an axial channel 54 located on the upper side of the flange 20 into a further axial channel 56, which is provided in the housing 18 of the final drive 10 and extends axially toward the outside and radially toward the inside at an angle to the axis of symmetry of the axle 30. The further channel 56 ends adjacent to the axle 30, at a location offset axially toward the outside with respect to the inner bearing assembly 36, at a radial distance from the axle 30.

The pump 52 can be driven by any shaft within the differential 12, e.g. the drive shaft or one of the input shafts 14. It would also be conceivable to drive the pump 52 continuously by a separate motor.

A tubular bushing 58, which surrounds the axle 30 and does not rotate with the axle 30, but is attached non-rotatably to the housing 18, is inserted into the housing 18. The bushing 58 extends in the axial direction between the inner bearing assembly 36 and the outer bearing assembly 34. In the embodiment illustrated, channels 60 are formed in the bushing 58, said channels extending from an axially inner end 78, which is adjacent to the outer end 76 of the further channel 56, as far as an axially outer end 80. Overall, two channels 60 are provided, these being arranged in pairs and adjacent to one another in the circumferential direction. The channels 60 comprise a radial section adjacent to the inner end 78, and an adjoining axial section. The channels 60 are aligned with the further channel 56 in the direction of rotation, thus enabling the lubricant to flow out of the further channel 56 into the two channels 60 of the bushing 58.

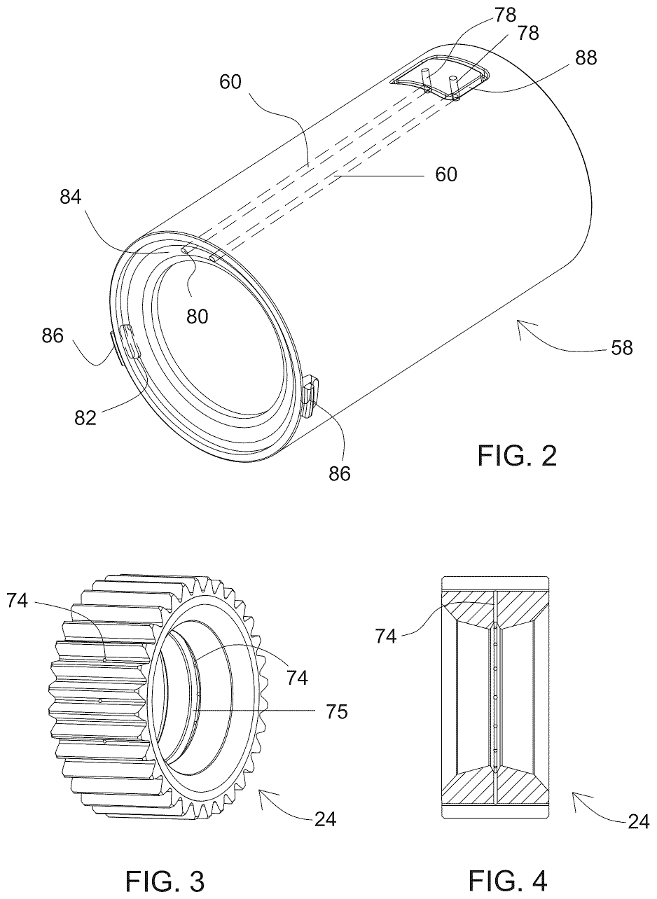

The outer end 80 of the channels 60 of the bushing 58 is aligned radially and axially with the rolling bearings of the outer bearing assembly 34, thus ensuring that lubricant entering from the channel 60, preferably distributed in an annular depression 84 (cf. FIG. 2) at the outer end of the bushing 58, flows toward the outside axially along the rolling bearings of the outer bearing assembly 34. At the outer end of the rolling bearings of the outer bearing assembly 34, the lubricant then enters a channel 82, which initially extends radially on the outside of the rolling bearings of the outer bearing assembly 34 and carries the lubricant axially toward the inside. There, it flows through a part of the channel 82 which extends radially through the bushing 58 and, on the inside of the bushing 58, enters an intermediate space 64, arranged there, between said bushing 58 and the axle 30. By this intermediate space 64, the lubricant is carried back axially toward the inside, where it enters a channel 68, which extends radially toward the outside and carries the lubricant to the rolling bearings of the inner bearing assembly 36.

The lubricant flows radially toward the outside and axially toward the inside along the rolling bearings and enters a collecting pocket 62 of a guide element 66. Then from the collecting pocket 62, the lubricant enters three channels 70 of the guide element 66. The guide element 66 rotates with the planet carrier 22. The channels 70 of the guide element 66 are aligned with the planet wheels 24, and the lubricant from the channels 70 flows directly into channels 72 of the planet carrier 24, which extend axially toward the inside and radially toward the outside and feed the lubricant to the bearing assemblies 28 approximately centrally. On the inside, the planet wheels 24 are provided with axially centrally arranged V-shaped grooves 75 and with central, radially extending channels 74 which start from the grooves 75 and are distributed around the circumference of the planet wheels 24 and through which the lubricant collected in the grooves 75 reaches the outer circumference of the planet wheels 24, where the surfaces in mesh with the annulus 26 and the sun wheel 16, and the surfaces of the annulus 26 and of the sun wheel 16, are supplied with lubricant. From there, the lubricant ultimately returns to the reservoir 50.

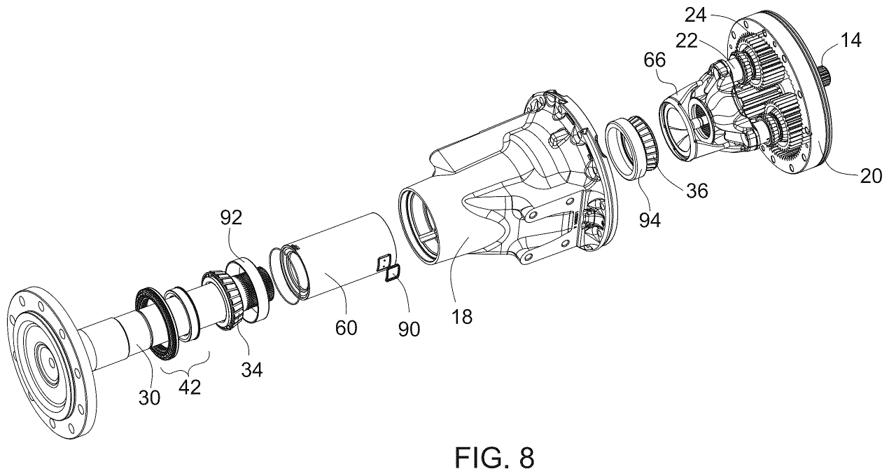

FIG. 2 shows a perspective view of the bushing 58. Features 86, by which it can be latched in the housing 18, are provided at its outer end. It can also be seen that a rectangular groove 88, in which it is possible to position a seal 92 (see FIG. 8) that comes into contact with the housing 18 and prevents unwanted outflow of lubricant, is provided around the inner ends 78 of the channels 60.

FIGS. 3 and 4 show a planet wheel 24 in perspective view and in section.

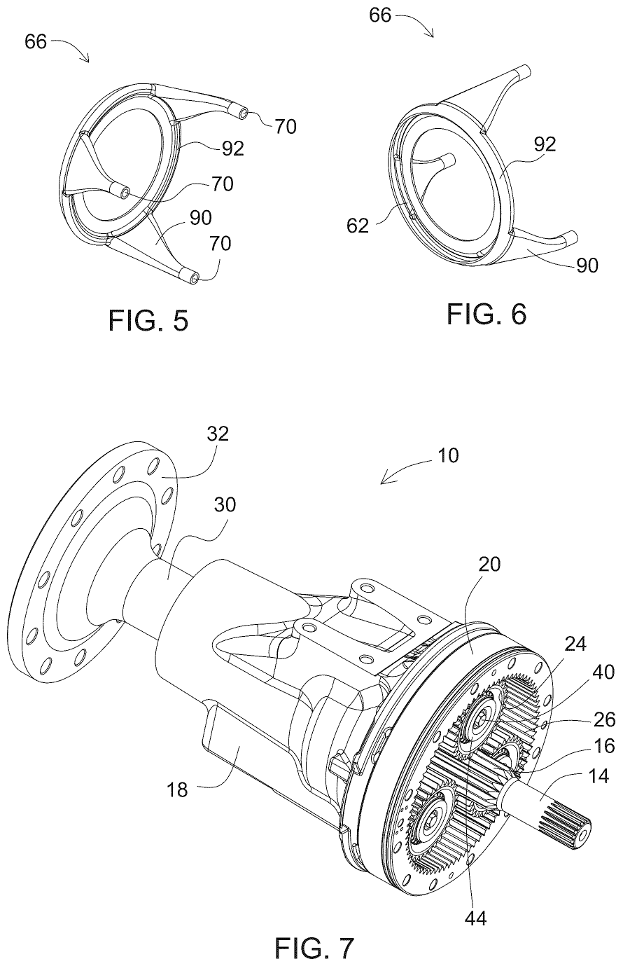

FIGS. 5 and 6 show the guide element 66 from the outside and from the inside in a perspective view. The channels 70 are arranged in legs 90 which extend radially toward the outside and axially toward the inside from an annular body 92 in such a way as to spread out. The channels 70 narrow in a funnel shape in the circumferential direction from the inlet to the outlet.

FIGS. 7 and 8 show the final drive 10 in a perspective view, on the one hand in the assembled state and on the other hand in an exploded view.

Given all that has been stated above, it can be seen that the final drive 10 under consideration involves continuous active supply with lubricant. The lubricant flows in a continuous circuit from the reservoir 50, is subjected to pressure by the pump 52, flows through the channels 54, 56, 60 (which form a first channel section) to the rolling bearings of the outer bearing assembly 34, from there flows through the channel 82 and the intermediate space 64 into the channel 68 (of which the latter three form a second channel section), from there flows to the rolling bearings of the inner bearing assembly 36, from there flows through the channels 70 and 72 (which both form a third channel section) to the rolling bearings of the bearing assemblies 28 and, from there, flows through the channels 74 to the planet wheels 24 and ultimately back into the reservoir 50.

What is claimed is:

1. A lubricant supply system for a final drive, the final drive including a housing, an input shaft, a planetary gear, and a drivable axle supported on the housing by an inner bearing assembly and an outer bearing assembly, configured to be driven by the input shaft via the planetary gear, and coupled to a wheel flange for receiving a wheel, the lubricant supply system comprising:
a first channel section, with which the outer bearing assembly can be supplied with a lubricant from a reservoir by a pump,
a second channel section, with which the lubricant can be carried from the outer bearing assembly to the inner bearing assembly, and
a third channel section, with which the lubricant can be carried from the inner bearing assembly to the planetary gear.

2. The lubricant supply system of claim 1, wherein the planetary gear includes a sun wheel connected to the input shaft, a planet carrier coupled to the drivable axle with planet wheels rotatably supported thereon by bearing assemblies, and an annulus, and wherein the lubricant can be fed to the bearing assemblies of the planet wheels through the third channel section, which runs at least partially through the planet carrier.

3. The lubricant supply system of claim 2, wherein the planetary gear is arranged within a flange connected to the housing.

4. The lubricant supply system of claim 2, wherein the planet wheels are equipped with radially extending channels distributed around the circumference, through which the lubricant can be carried from the bearing assemblies of the planet wheels to the circumference of the planet wheels.

5. The lubricant supply system of claim 4, wherein the radially extending channels in the planet wheels are arranged approximately centrally in the axial direction.

6. The lubricant supply system of claim 3, wherein the reservoir and the pump are arranged within a differential connected to the flange, through the differential the input shaft is drivable, and the first channel section includes an axial channel, which extends from the differential through the flange, and a further channel, which connects to the axial channel and extends through the housing.

7. The lubricant supply system of claim 6, wherein an axially inner end of a channel of the first channel section is adjacent to the outer end of the further channel within a bushing arranged non-rotatably in the housing, and the channel carries the lubricant to the outer bearing.

8. The lubricant supply system of claim 7, wherein the second channel section is formed at least partially by an intermediate space between the bushing and the drivable axle.

9. The lubricant supply system of claim 2, wherein the inner bearing assembly is adjacent to a guide element, which is secured on the planet carrier, wherein the guide element and a collecting pocket adjacent to the inner bearing assembly for lubricant discharged from the inner bearing assembly and channels of the guide element extending to channels arranged within the planet carrier, wherein the channels of the planet carrier carry the lubricant to the bearing assemblies of each planet wheel, and the channels of the guide element together with the channels of the planet carrier form at least parts of the third channel section.

10. A final drive, comprising:
a housing,
an input shaft,
a planetary gear,
a drivable axle supported on the housing by an inner bearing assembly and an outer bearing assembly, configured to be driven by the input shaft via the planetary gear, and coupled to a wheel flange for receiving a wheel, and
a lubricant supply system including:
a first channel section, with which the outer bearing assembly can be supplied with a lubricant from a reservoir by a pump,
a second channel section, with which the lubricant can be carried from the outer bearing assembly to the inner bearing assembly, and
a third channel section, with which the lubricant can be carried from the inner bearing assembly to the planetary gear.

11. An axle assembly for a rear axle of an agricultural tractor, comprising:
a differential, and
final drives arranged on both sides of the differential, each of the final drives including:
a housing,
an input shaft,
a planetary gear,
a drivable axle supported on the housing by an inner bearing assembly and an outer bearing assembly, configured to be driven by the input shaft via the planetary gear, and coupled to a wheel flange for receiving a wheel, and
a lubricant supply system including:
a first channel section, with which the outer bearing assembly can be supplied with a lubricant from a reservoir by a pump,
a second channel section, with which the lubricant can be carried from the outer bearing assembly to the inner bearing assembly, and
a third channel section, with which the lubricant can be carried from the inner bearing assembly to the planetary gear.
